(19) United States
(12) Patent Application Publication
(10) Pub. No.: US 2023/0120812 A1
(43) Pub. Date: Apr. 20, 2023

(54) Organic Water-Soluble Fertilizer with Humic Properties

(71) Applicant: Novihum Technologies GmbH, Dortmund (DE)

(72) Inventor: Horst NINNEMANN, Froendenberg/Ruhr (DE)

(73) Assignee: Novihum Technologies GmbH, Dortmund (DE)

(21) Appl. No.: 17/910,043

(22) PCT Filed: Mar. 9, 2021
(86) PCT No.: PCT/EP2021/055866

§ 371 Date: Sep. 8, 2022

(30) Foreign Application Priority Data
Mar. 11, 2020 (EP) 20162500.1

(51) Int. Cl. C05F 11/02; C05C 3/00; C05G 5/10

(52) U.S. Cl. CPC C05F 11/02; C05C 3/005; C05G 5/10

(57) ABSTRACT

The invention relates to an organic water-soluble fertilizer, in solid form, with humic properties, comprising carbon and nitrogen with a carbon-to-nitrogen ratio of between 4 to 14, wherein more than 0% and up to 30% of the total nitrogen content is chemically bound as ammonium nitrogen, more than 0% and up to 20% of the total nitrogen content is chemically bound as easy-to-hydrolyse amide nitrogen and at least 50% of the total nitrogen content is chemically bound as difficult-to-hydrolyse amide nitrogen. The invention further relates to a method for producing an organic water-soluble fertilizer provided in solid form and the use of such a water-soluble fertilizer.

The invention relates to an organic water-soluble fertilizer, in the form of a solid, with humic substance properties. Furthermore, the invention relates to a method for the preparation of an organic water-soluble fertilizer, in the form of a solid, with humic substance properties. Moreover, the invention relates to the use of an organic water-soluble fertilizer, in the form of a solid, with humic substance properties for the subsequent soil conditioning of already existing plant stands and/or as a biostimulant for reducing plant stress.

Due to its chemical properties and availability lignite has already found interest for some time as a starting material for the preparation of substances or mixtures of substances with fertilizing effects.

Water-soluble alkaline extracts from sources rich in humic substances such as for example lignite (humic substance extracts, humic acid, fulvic acids) are marketed as biostimulants for example for use in cultivation of plants. Such products are inherently low-nitrogen humic acid preparations with fossil properties. The percentage of nitrogen which is chemically integrated into the molecule structure of such fertilizer products, in particular the percentage of sparingly hydrolysable amide nitrogen, is low. A product with a high percentage of sparingly hydrolysable amide nitrogen would be advantageous, in particular in view of a long-term fertilizer effect and soil conditioning. Further, amide-like structural features are indicators of high-grade humus substances as they occur in particular in fertile soils, while humic substances having only a low percentage of nitrogen-containing structural units are indicative of less fertile soils. As a result, the positive influence on soil fertility requires the availability of humus substances that correspond in structure to the high-grade humus substances found in nature (Scheffer, F.: Lehrbuch der Bodenkunde. 14^{th} edition, p. 53 ff. and p. 383 ff.).

An example of the use of humic substances from sources rich in humic substances such as lignite is described in RO 129 938. Here, a liquid fertilizer is described which is a multi-component fertilizer (NPK) in which e.g., ethylenediamine tetraacetic acid is to keep the nutrients, meso and trace elements in solution and is to facilitate absorption of said compounds by plants into the leaf system. One component of the liquid fertilizer is a lignite-derived solution of humic substances which contain humates and potassium fulvates. Since no nitrogen is introduced in the preparation of said humic substance solution (no oxidative ammonolysis is carried out) the products in question are the above-described inherent low-nitrogen humic acid preparations with fossil properties. The chemical bond of the nitrogen in the humins of RO 129 938 is not changed such that in particular the content of sparingly hydrolysable amide nitrogen in the product is very low, if such a nitrogen is present at all.

WO 2017/186852 A1 describes a method for the preparation of an organic fertilizer with humic substance properties by oxidizing and ammoniating treatment of lignite (oxidative ammonolysis). With the method described there, which can also be referred to as artificial or standardized humification, an organic fertilizer with humic substance properties is generated as a solid. However, said organic fertilizer is sparingly water-soluble and therefore should be introduced into the soil before appropriate plantation measures. Due to the poor water-solubility of the fertilizer generated with said method a subsequent application for existing plant stands is associated with considerable difficulties.

A problem of the invention is to provide an organic water-soluble fertilizer, in the form of a solid, with humic substance properties which, due to its water-solubility, can be introduced into already existing plant stands for subsequent application and which does not have the drawbacks of the known water-soluble fertilizers derived from lignite. A further problem of the invention is to provide an organic water-soluble fertilizer, in the form of a solid, with humic substance properties which can be used as a biostimulant. Moreover, it is the problem of the invention to provide a method for the preparation of an organic water-soluble fertilizer, in the form of a solid, with humic substance properties. Moreover, it is the problem of the invention to provide an organic water-soluble fertilizer, in the form of a solid, with humic substance properties which can be obtained in accordance with the method described here.

Said problems are solved by the object of the claims.

The invention therefore provides an organic water-soluble fertilizer, in the form of a solid, with humic substance properties comprising

carbon and nitrogen in a carbon-to-nitrogen ratio of 4 to 14, wherein
more than 0% and up to 30% of the total nitrogen content is chemically bound as ammonium nitrogen,
more than 0% and up to 20% of the total nitrogen content is chemically bound as easy-to-hydrolyse amide nitrogen and/or easy-to-hydrolyse amide-like bound nitrogen, preferably as easy-to-hydrolyse amide nitrogen; and
at least 50% of the total nitrogen content is chemically bound as difficult-to-hydrolyse amide nitrogen and/or difficult-to-hydrolyse amide-like bound nitrogen, preferably as difficult-to-hydrolyse amide nitrogen.

The percentage of ammonium nitrogen and amide nitrogen and/or amide-like bound nitrogen, preferably amide nitrogen, in the fertilizer according to the invention can be determined by means of Kjeldahl nitrogen determination, as described in the example of the application or in Pansu & Gautheyrou: Handbook of Soil Analysis (2003), pp. 497 ff.

The term “fertilizer”, in accordance with the invention, is meant to be a pure substance or mixture of substances which completes the nutrient supply for cultivated crop plants and improves the quality of the soil for already existing plant stands and/or can be used as a biostimulant, e.g., for reducing plant stress.

In the context of the description of the present invention the organic water-soluble fertilizer, in the form of a solid, with humic substance properties briefly is referred to as water-soluble fertilizer.

In the water-soluble fertilizer according to the invention the total nitrogen content is high and a high percentage of the nitrogen is chemically integrated into the molecular structure of the components of the water-soluble fertilizer, in particular as amide nitrogen and/or amide-like bound nitrogen, preferably as amide nitrogen, so that it represents an integral component of the structure of the water-soluble fertilizer according to the invention. As a result, the water-soluble fertilizer matches with the chemical properties of recent humic acids of fertile soils. Recent humic acids are formed from contemporary carbon and are opposed to the humic acids from fossil sources, such as e.g., from peats or coal. The water-soluble fertilizer described here differs from the known water-soluble humates, i.e., from known fertilizers, which are derived from lignite, in particular by the high percentage of chemically bound nitrogen. That's why the water-soluble fertilizer described here exhibits a particularly good efficacy, in particular in case of long-term fertilization.

In the following, the invention is described for the embodiment “amide nitrogen” (which is preferred). The term “amide nitrogen” in the following is used in terms of amide nitrogen and/or amide-like bound nitrogen, preferably amide nitrogen.

The term “water-soluble fertilizer” is understood to mean that one part of the fertilizer is soluble in up to 5000 parts of water, preferably in up to 1000 part of water, in particular in less than 500 parts of water (each at 20° C.).

In the context of the present application a fertilizer is regarded as being water-soluble if it forms either a true solution or a colloidal solution. A colloidal solution is also referred to as a colloidal dispersion or colloidal suspension.

In particular, the water-soluble fertilizer is a colloid dispersion. Water-soluble fertilizers with humic substance properties, as described in the application, are also referred to as hydrophilic colloids.

Colloidal dispersions (the term “colloid” and “colloidal” in this case are used synonymously) according to the application are systems in which microscopic particles are present finely dispersed in a medium, the dispersion medium. The particles are not soluble in the dispersion medium. The size of the individual particles is typically in the range from 1 nanometer to 1 micrometer. Here, it should be noted that the particle size may only refer to a dimension if the particles are plate-like particles, for example. However, the particles may also be rod-shaped (two-dimensional) or spherical (three-dimensional). The size of the particles can be determined by means of known methods, e.g., by electron microscopy, light scattering, radiography, and neutron scattering, etc.

Colloidal dispersions, above all, are characterized in their specific colloidal properties, such as for example by the uniform distribution of the particles in the dispersion medium, which is not changed in a defined period of observation. Moreover, the Tyndall effect occurs with colloidal dispersions or suspensions, respectively.

Disperse systems of almost the same particle size are referred to as monodisperse or isodisperse, such of different particle size as polydisperse. Preferably, the water-soluble fertilizer, as described in the application, is a polydisperse system.

The term “humic substance properties” is a technical term known to the skilled person. According to the wording it is to be understood that the water-soluble fertilizer has the properties of humic substances. Humic substances include the fulvic acids such as the hymatomelanic acids, the humic acids, and the humins (Fiedler, H. J. and Reissig, H.: Lehrbuch der Bodenkunde, Gustav Fischer Verlag Jena, 1964, page 174, item 4.423). The humic substances that are contained in the water-soluble fertilizer according to the invention and give the fertilizer the humic substance properties differ from the naturally occurring humic substances in that they are water-soluble and due to the manufacturing method have a very high content of chemically bound nitrogen. Thus, “humic substance properties”, as is understood by the skilled person, means that the fertilizer contains water-soluble humic substances.

As used herein, the abbreviation “wt. %” represents weight percentages and refers to the weight of a percentage with respect to a total weight. In the context of the present description of the invention there is given at the appropriate point or is readily apparent to the skilled person from the overall context which percentage is meant and to which total weight this percentage does refer.

Unless stated otherwise or obvious from the context % data refer to the weight and ratios to weight ratios.

In the context of said application, “easy-to-hydrolyse amide nitrogen” means the percentage of the total nitrogen content of the water-soluble fertilizer which can be released from a sample with sodium hydroxide solution by means of vapor distillation, minus the ammonium nitrogen (Kjeldahl nitrogen determination).

In the context of said application, “difficult-to-hydrolyse amide nitrogen” means the percentage of the total nitrogen content of a sample of the water-soluble fertilizer which is calculated as follows:

Percentage of difficult-to-hydrolyse amide nitrogen=

Percentage of total nitrogen—Percentage of easy-to-hydrolyse amide nitrogen—Percentage of ammonium nitrogen.

Here and in the following, “total nitrogen content” means the total percentage of nitrogen in the water-soluble fertilizer. The total nitrogen content can be determined by means of common elemental analytical methods (e.g., with an instrument of Elementar (vario EL cube, https://www.elementar.com/de/produkte/organische-elementaranalyse/vario-el-cube.html, see also Pansu & Gautheyrou: Handbook of Soil Analysis (2003), p. 327 ff.).

The total nitrogen content is the sum of ammonium nitrogen, easy-to-hydrolyse, and difficult-to-hydrolyse amide nitrogen.

The organic water-soluble fertilizer with humic substance properties described here is a water-soluble humic acid preparation rich in nitrogen which has integrated nitrogen in its chemical structure and is used for example in landscaping, commercial and ornamental horticulture, fruit and vegetable production, agriculture, and the like. It has high-quality humic acids as are also found in fertile soils. Previously known extracts from lignite for use as a fertilizer result in low-nitrogen humic acid preparations with fossil properties and accordingly have no high-quality humic acids.

According to at least one embodiment the water-soluble fertilizer has a total nitrogen content from 3 wt. % to 11 wt. % with respect to the dry weight of the fertilizer. Preferably, the total nitrogen content is from 4 wt. % to 9 wt. %, more preferably from 4 wt. % to 8 wt. %, and particularly preferred from 4 wt. % to 6 wt. % with respect to the dry weight of the fertilizer.

The water-soluble fertilizer is in the form of a solid. This in particular means that the water-soluble fertilizer is in a solid state of aggregation at least at room temperature (20° C. to 30° C., preferably 25° C.). The solid may be present e.g., in powder form as a granule or as pellets.

The water-soluble fertilizer has a carbon-to-nitrogen ratio from 4 to 14, preferably from 6 to 13, more preferably from 8 to 12, particularly preferred from 9 to 11, for example 10.

In the water-soluble fertilizer more than 0% and up to 30% of the total nitrogen is chemically bound as ammonium nitrogen. Chemically bound ammonium nitrogen is the percentage of nitrogen present in the form of ammonium (NH₄⁺). Preferably, in the water-soluble fertilizer from 20% to 30%, more preferably from 23% to 28%, for example 25%, of the total nitrogen content is chemically bound as ammonium nitrogen.

In the water-soluble fertilizer more than 0% and up to 20% of the total nitrogen content is chemically bound as easy-to-hydrolyse amide nitrogen. Chemically bound amide nitrogen is the percentage of nitrogen present in the form of amides. Preferably, from 5% to 18%, more preferably from 10% to 15%, for example 12%, of the total nitrogen content is chemically bound as easy-to-hydrolyse nitrogen.

In the water-soluble fertilizer at least 50% or more, preferably 60% or more, more preferably 65% or more, in particular 70% or more, for example 72.5% of the nitrogen content is chemically bound as difficult-to-hydrolyse amide nitrogen.

Preferably, the total nitrogen content consists of the percentages of the ammonium nitrogen, of the easy-to-hydrolyse amide nitrogen, and of the difficult-to-hydrolyse amide nitrogen, so that the sum of said percentages forms 100% of the total nitrogen percentage or content.

The water-soluble fertilizer can comprise further elements, such as potassium, calcium, silicon, and/or phosphor.

The water-soluble fertilizer usually contains carbon, hydrogen, oxygen, and sulphur in addition to nitrogen.

Preferably, the water-soluble fertilizer can be obtained in that it is subjected to an oxidizing and ammoniating treatment of lignite. The term “oxidizing and ammoniating treatment” is known to the skilled person. This is preferably done with the method described here. An oxidizing and ammoniating treatment often is also referred to as an oxidative ammonolysis. Oxidative ammonolysis has already been described by Flaig et al., (1959), for example in Umwandlung von Lignin in Huminsäure bei einer Verrottung von Weizenstroh” Chem. Ber., 92 8, 1973-1982. Moreover, the oxidizing and ammoniating treatment of lignite is described in WO 00/37394, WO 2017/186852 A1, and WO 2018/215508 A1.

Further, the invention relates to the use of the water-soluble fertilizer.

According to one embodiment, the water-soluble fertilizer can be used for the subsequent soil conditioning of already existing plant stands. Alternatively or additionally, the water-soluble fertilizer can be used as a biostimulant for reducing plant stress or for strengthening plants.

The water-soluble fertilizer contributes to soil conditioning by humic substances. Because of the chemically bound nitrogen in the form of ammonium nitrogen and/or amide nitrogen a very good plant fertilization can be achieved with the water-soluble fertilizer. In particular, the high percentage of amide nitrogen results in a delayed or particularly long-lasting fertilization effect.

The nitrogen is present chemically bound in the water-soluble fertilizer in different ways. On the one hand, the nitrogen is present in the form of ammonium and thus, is short-term available for plants. On the other hand, the nitrogen is present in different hydrolysable amide forms. Said nitrogen in amide form is medium-term or long-term available for plants.

For application, the water-soluble fertilizer in general is dissolved in water. The concentration of the water-soluble fertilizer in the aqueous solution intended for use depends on the application, the soils to be fertilized, the type of plant, and the state of growth, etc.

Generally, the concentration of the water-soluble fertilizer in the solution intended for use is in the range from 0.005% to 5%, preferably in the range from 0.01% to 2%, more preferably in the range from 0.1% to 1.5%, particularly preferred in a range from 0.5 to 1.0%, e.g., 0.7%.

If it is intended to use the water-soluble fertilizer as a biostimulant for reducing plant stress, the concentration of the water-soluble fertilizer generally is in the range from 0.01% to 0.8%, preferably from 0.1% to 0.6%, e.g., 0.2%.

If it is intended to use the water-soluble fertilizer for the subsequent soil conditioning of already existing plant stands, the concentration of the water-soluble fertilizer generally is in the range from 1% to 5%, preferably from 2 to 4%.

The aqueous solution intended for use may also contain further substances for soil conditioning, pest control, weed control, etc. in addition to the water-soluble fertilizer according to the invention. Such substances are known to the skilled person.

In particular, the water-soluble fertilizer according to the invention has chemical compounds of the general structure NH₄—R with R═CₓH_{Y}O_{Z}N_{V}. The values for x, y, z, and/or v result from the values for C, H, O, and N determined by means of elemental analysis and the corresponding calculation. The ammonium nitrogen (NH₄⁺) can separately be determined. Unlike with the known commercially available ammonium humates a very high percentage of the active ingredient is not present as (short-term acting) ammonium nitrogen in the products according to the invention, but as a result of the artificial humification of the lignite by an oxidizing and ammoniating treatment to a very considerable extent as amide nitrogen chemically bound in residue R.

Furthermore, the invention relates to a method for the preparation of the water-soluble fertilizer with humic substance properties according to the invention. Here, all the definitions and explanations for the water-soluble fertilizer also apply to the method for the preparation of the water-soluble fertilizer and vice versa.

The method is an oxidizing and ammoniating treatment of lignite leaned on the method of WO 2017/186852 A1. It has surprisingly been found that a product is formed in an intermediate stage of the method of WO 2017/186852 A1 from which the fertilizer in the solid form according to the invention can be prepared in an easy manner. This way, economic efficiency of the known method is increased. Thus, for details of the method of the oxidizing and ammoniating treatment of lignite reference may be made to the method of WO 2017/186852, unless no deviation results from the following description.

The method according to the invention is carried out as a continuous method and comprises the following steps:

a) feeding lignite particles and/or lignin particles, preferably lignite particles and aqueous ammonia solution as well as optionally recovered product of step b) as starting materials into a dispersing circuit having a dispersing device, a recirculation container, and a circulation pump, and dispersing the starting materials while simultaneously reducing the lignite particles and/or lignin particles, preferably lignite particles, in size until a suspension of lignite particles and/or lignin particles, preferably lignite particles, and aqueous ammonia solution is formed that is taken out of the dispersing circuit and transferred to step b);

b) oxidizing the suspension obtained in step a) in an oxidation reactor with an oxygen-containing oxidizing agent at a temperature of <100° C., thereby forming a product suspension;

c) separating a liquid phase from the product suspension,

d) drying the liquid phase obtained in step c), preferably at a temperature>50° C., wherein the organic water-soluble fertilizer with humic substance properties is generated as a solid; and optionally

e) cooling the solid organic water-soluble fertilizer obtained in step d).

In the following the invention is described in detail for the preferred embodiment of the lignite particles, however the explanations equally apply to lignins. The lignins in particular are technical lignins resulting e.g., from the pulp production as waste products or in biorefineries.

Thus, the method described here corresponds to the method described in WO 2017/186852 A1, wherein the liquid phase of the product suspension is processed to the solid organic water-soluble fertilizer with humic substance properties.

Also, formulation of the liquid phase obtained in process step c), in the following referred to as liquid product, to the finished final application can take place instead of step d), that is, the liquid product obtained in process step c) can directly be used as a fertilizer. For that, excess NH₃ can thermally or chemically in part or completely be removed. The excess ammonium (free ammonia) thus obtained can be used elsewhere or returned to the method according to the invention.

The liquid product obtained in step c) is a colloidal suspension with humic substance properties which has the properties described with respect to the water-soluble fertilizer in the solid form.

In step d) the organic water-soluble fertilizer with humic substance properties is generated as a solid. Said solid water-soluble fertilizer first is obtained in powder form, but may be processed for example to a granule and/or pellets in a usual manner. In particular, the water-soluble fertilizer has a residual moisture content of at most 30 wt. %, with respect to the total weight of the dried product. Preferably, the dried product has a residual moisture content of 25 wt. %, with respect to the total weight of the dried product. In particular, the dried product has a residual moisture content of at most 20 wt. %, with respect to the total weight of the dried product.

The term “continuous method” within the context of the invention described here has to be understood such that starting materials that in the present case particularly are lignite and aqueous ammonia solution as well as optionally recovered product of step b), are continuously fed to the method and converted to liquid and/or dried product via the steps a) to c) and optionally d) without the need to interrupt the method or the process steps to form the product and to withdraw it from the process.

The term “dispersing circuit” indicates an arrangement comprising a dispersing device, a recirculation container, and a circulation pump. This also encompasses that the dispersing device and the circulation pump are disposed in an aggregate.

Here, as much starting materials are continuously fed into the dispersing circuit in process step a) as suspension product is taken out and fed to step b), so that the substance volume in the dispersing circuit remains substantially constant. Also, as much of the suspension obtained in step a) is continuously fed into the oxidation reactor in step b) as oxidized product suspension is taken out and completely fed to step c) or partially to step c) and/or partially to step a) as starting material.

The term “suspension”, as used herein, indicates a suspension of lignite particles and aqueous ammonia solution, that, as described herein, is obtained by dispersing or blending lignite particles and aqueous ammonia solution as well as optionally recovered product of step b) in the dispersing device. The term “suspension” also encompasses that a part of the lignite dissolves, i.e., the suspension is a mixture of lignite suspension and lignite solution in aqueous ammonia.

According to at least one embodiment the aqueous ammonia solution used in step a) is obtained by dissolving ammonia in water. The aqueous ammonia solution or its starting materials water and ammonia, respectively may also be recovered from the reaction process, in particular from steps c) and d), and made available to the method again. In this way, the economic efficiency of the method is increased.

The aqueous ammonia solution preferably has an ammonia concentration of up to 10 wt. %. In particular, the concentration of the aqueous ammonia solution is at least 2 wt. %, based on the total weight of the aqueous ammonia solution. A concentration of 3 to 8 wt. % is more preferred, and especially preferred of 4 to 6 wt. %, each based on the total weight of the aqueous ammonia solution.

The pH value of the aqueous ammonia solution is preferably between 9 and 12.

The present method enables the use of lignite particles as a starting product the size of which does not play a decisive role since the lignite particles are reduced in size during the method at least in step a). For practical reasons lignite of mean particle sizes of >10 μm is preferably employed, wherein lignite particles of particle sizes of e.g., up to 10 mm can also be employed. Lignite particles of particle sizes up to 5 mm are more preferred, more preferably up to 2 mm, more preferably up to 1 mm. The lignite particles are preferably lignite dust of typical mean particle sizes in the range of more than 10 μm and up to 600 μm, especially in the range of 200 μm to 300 μm. As an alternative, however also raw lignite of particle sizes up to 10 mm can be used, wherein this is reduced in size in the dispersing circuit. This broadens the range of applications of the method. The method can start with a further process step, for example reducing the lignite in size, for example by grinding.

It is possible to employ lignites from different locations as the starting material. The lignite can be used in a mixture with technical lignins of the pulp industry as well as wood hydrolysis, lignite in a mixture with lignin as well as lignocellulose material from the steam explosion digestion for the manufacture of fibers, and lignite in a mixture with microcellulose material such as wood and bark particles. Said mixtures can be used in the method as pre-blends and obtained by blending the individual components and the aqueous ammonia solution in the dispersing device.

According to at least one embodiment, the dispersing device used in step a) is a mixing device and a comminuting device at the same time. Here, the mixture of lignite particles and aqueous ammonia solution as well as optionally recovered product of step b) can be blended in the dispersing device while simultaneously reducing the lignite particles in size until there is obtained a dispersion of size-reduced lignite particles and aqueous ammonia solution. By reducing the lignite particles in size in the dispersing device it is possible to obtain lignite particles with a relatively uniform particle size distribution what makes it possible to form a particularly homogenous dispersion that is fed to oxidation in step b).

Preferably, the lignite particles are reduced to a mean particle size of <10 urn, more preferably to a mean particle size of <8 urn, still more preferably to a mean particle size of <6 urn, and especially to a mean particle size<4 urn in the dispersing device. Reducing the lignite particles is size is of advantage in that the reaction surfaces are increased and thus, the mean size distribution is relatively uniform what favors step b). The mean particle size is a volume-average particle size. This can be determined by laser diffraction, for example.

The measurement of the volume-average particle size is known to the skilled person and is found, for example in WO 2017/186852 A1. The disclosure content of WO 2017/186852 A1 for the measurement of the volume-average particle size is incorporated herewith by reference.

Reducing the lignite particles in the dispersing device can be done by means of a rotor-stator gear rim system. The rotor-stator gear rim system can have different gap sizes, so that the degree of the size reduction can be determined by selecting the respective rotor-stator gear rim system. Such systems are sufficiently known from the prior art and thus, are not explained in detail here.

Preferably, the dispersing device is a closed system, so that gas exchange with the environment is suppressed. The dispersing device may be for example a dispersing device of the models of the MT-VP series. These are known to the skilled person, for example from EP 1 674 151, the disclosure content of which is incorporated by reference, and thus, are not explained in detail here.

According to at least one embodiment, the dispersing chamber is adapted such that flow ratios generally are turbulent and highly dispersing of the substances in the liquid is favored.

Preferably, an oxidizing agent is directly added to the dispersing device, in particular to the dispersing chamber. The oxidizing agent may be for example an oxygen-containing gas selected from oxygen, oxygen-enriched air or air. Further, the oxidizing agent may be for example ozone or hydrogen peroxide, such as an aqueous hydrogen peroxide solution. Preferably, an oxygen-containing gas, in particular air is added.

The circulation pump can pump the mixture of lignite particles and aqueous ammonia solution through the dispersing circuit. The circulation pump may be part of the dispersing device. The circulation pump sucks off the suspension from the recirculation container and blows it into the dispersing device.

After having passed through the dispersing device the lignite suspension again can enter the recirculation container. Therefrom the lignite suspension obtained in the dispersing device is continuously withdrawn from the circulation and made available to step b). In order to prevent settling, the recirculation container can be equipped with stirrers.

The percentage of the lignite particles and of the aqueous ammonia solution may be employed in a ratio of for example 30 wt. % of lignite particles to 70 wt. % of the aqueous ammonia solution. Said values each refer to the total weight of the mixture of lignite particles and aqueous ammonia solution.

Alternatively, at least 10 wt. % of lignite particles and 90 wt. % of the aqueous ammonia solution may be employed. Preferably, at least 12 wt. % of lignite particles to 88 wt. % of the aqueous ammonia solution may be employed.

The mean retention time of the mixture of lignite particles, aqueous ammonia solution as well as optionally recovered product of step b) in the dispersing device may be for example 6 hours.

As the mean retention time in the context of said invention a period may be understood in which a certain event is achieved, for example formation of the suspension in step a) or oxidation in step b), separation in step c), optionally drying of the product in step d) or cooling in step e).

Preferably, the mean retention time of the starting materials added in step a) is 30 to 300 min, more preferably 45 to 240 min, particularly preferred 60 to 180 min. The mean retention time is calculated as usual with the continuous process control from the total volume of the dispersing device and the added and/or withdrawn volumes.

The suspension obtained in step a) may be supplied to step b) via the recirculation container of the dispersing circuit. In step b) the suspension that was obtained in step a) is laced with an oxygen-containing oxidizing agent in an oxidation reactor at a temperature of <100° C.

Preferably, the temperature in the oxidation reactor is at least 50° C., more preferably between 60 and 90° C., especially preferred between 70 and 80° C.

The oxidizing agent may be an oxygen-containing gas. Alternatively, the oxygen-containing oxidizing agent may be ozone or hydrogen peroxide.

Preferably, the oxygen-containing gas is added with an excess pressure of at least 0.15 MPa, more preferably an excess pressure of 0.2 to 0.8 MPa (2 to 8 bar), even more preferred an excess pressure of 0.3 to 0.7 MPa (3 to 7 bar) and particularly preferred an excess pressure of 0.4 to 0.6 MPa (4 to 6 bar) is present.

The mean retention time of the suspension in the oxidation reactor is preferably 15 to 300 min., more preferably 30 to 240 min., especially preferred 45 to 120 min. The suspension resulting from step b) in the context of the method described here is referred to as product suspension. The product suspension contains the oxidation product.

Optionally, the oxidation reactor used in step b) can also be connected to a further dispersing circuit into which the lignite suspension can be introduced and recycled back from there into the oxidation reactor. Additional thoroughly mixing and size reduction of the lignite particles in the further dispersing circuit provides for an additional homogenization of the suspension. This, in turn may favor the oxidation reaction whereby in the end the nitrogen binding ratios in the product can be influenced. The further dispersing circuit in the method described here may be a dispersing circuit as described above with respect to step a).

Excessive gas, for example oxygen-containing oxidation gas and/or ammonia, may again be added to the suspension. The recovered ammonia for example can be used for producing the aqueous ammonia solution in step a). In doing so, economic efficiency of the method can be increased.

According to at least one embodiment a certain volume of the suspension from step a) can be continuously fed into the reactor and a certain volume of a product suspension can be continuously withdrawn from the reactor.

In process step c) a liquid phase is separated from the product suspension. Preferably, the separation is such that the liquid phase of the product suspension is partially or completely, preferably partially separated. In particular, the liquid phase is an aqueous phase. The liquid phase is supplied to step d).

The product suspension is formed from a solid phase and a liquid phase. In the method described here, in particular part of the liquid phase is separated. The remaining product suspension or the solid phase, respectively generally is processed as described in WO 2017/186852.

For example, the product suspension can continuously be withdrawn from the reactor e.g., via a receiving vessel. The receiving vessel may be under standard pressure. To prevent settling, the recirculation container is preferably equipped with further stirrers. According to a further embodiment the product suspension obtained from step b) may completely be supplied to step c).

According to a preferred embodiment separation in step c) is done gravity-based, for example by centrifugation. Centrifugation may be carried out discontinuously or continuously.

In at least one preferred embodiment centrifugation is done continuously, particularly preferred by means of a continuously working two-phase-decanter (e.g., two-phase decanter by GEA Westfalia Separator Group GmbH).

Duration of the separation step is preferably 2 to 60 min, more preferably 5 to 20 min, particularly preferred 8 to 15 min, e.g., 10 minutes.

The liquid phase separated in step c) is supplied to step d).

Step d) is a drying step. The drying step may be carried out in any device suitable to remove water from aqueous solutions and to convert them to a solid, for example drying may be done by means of a commercial thin layer evaporator.

Drying is preferably carried out at a temperature of >50° C., preferably >60° C., particularly preferred>70° C. Preferably, drying is done at a temperature of no more than 120° C., more preferably no more than 110° C. Drying is done up to the desired residual water content.

The mean retention time for drying is generally below 2 hrs, more preferably below 1 hr, more preferably below 0.5 hrs.

Drying may be done under standard pressure or reduced pressure with the drying preferably being done under standard pressure. Multi-stage drying at different pressures is possible. If drying is done under reduced pressure, then the drying time and/or the drying temperature may be chosen accordingly lower.

By drying the organic water-soluble fertilizer with humic substance properties in the form of a solid is formed. Preferably, the water-soluble fertilizer has a residual moisture content of at most 30 wt. %, more preferably, the water-soluble fertilizer has a residual moisture content of at most 25 wt. %, at most 20 wt. %, or at most 15 wt. %, with respect to the total weight of the dried product.

The vapors of ammonia and water that are formed during drying may be supplied for example to step a) again optionally after purification, e.g., by distillation.

Cooling of the product in the optional step e) may for example be done in a rotating drum. The drum may have a diameter in the range from 0.5 to 1.5 m and a length from 2 to 5 m, wherein the drum can move with a speed of 20 rpm.

Moreover, an agglomerating agent may be added to the drying step which has further influence on the product properties in view of grain size. In this way, also mechanical stability of the product can be increased. A fine-grained, dust-free product can be produced.

According to at least one embodiment step c) and/or step d) comprise removal of free ammonia.

Accordingly, with the method described here it is possible to produce an organic water-soluble fertilizer with humic substance properties which contributes to the subsequent soil conditioning and has nitrogen as an integral character in the chemical structure. Further, the product can be used as a biostimulant in the cultivation of plants.

The dried organic water-soluble fertilizer with humic substance properties which was produced for example can be dissolved by the end user and in this way introduced into already existing plant stands for the subsequent soil conditioning. When applied, the water-soluble fertilizer according to the invention is used in aqueous solution at the above-mentioned concentrations. Particularly advantageously, the fertilizer is applied in such a way that an amount from 50 to 500, preferably from 100 to 300, more preferably from 150 to 250 kilograms of the water-soluble fertilizer (calculated as solid) per hectare soil is applied, in particular for the subsequent soil conditioning in already existing plant stands.

If the water-soluble fertilizer according to the invention is used as a biostimulant for reducing plant stress and for strengthening plants, then the fertilizer is preferably applied such that an amount from 1 to 16, preferably from 4 to 14, more preferably from 6 to 10 kilograms of the water-soluble fertilizer (calculated as solid) per hectare soil is applied.

In particular, the organic water-soluble fertilizer in the form of a solid can be used for the subsequent humus accumulation in the topsoil of existing plant stands, such as e.g., vine, stone fruit, apples, citrus fruits, almonds. For that, for example 100 kg/ha (with respect to dry substance) of a 5% solution of the fertilizer are ground-proximately applied. Alternatively, the fertilizer may durably, but not necessarily permanently be applied via the irrigation system in a concentration of e.g., 0.1%.

In case of above-ground application into existing plant stands for strengthening plants and stress reduction the fertilizer according to the invention is applied by means of spray application. For that, e.g., 8 kg/ha of a 0.2% solution are applied by means of a crop sprayer.

For seed treatment, e.g., lawn seed, preferably a 0.1% solution is used.

The invention further relates to an organic water-soluble fertilizer with humic substance properties which can be obtained from the method described here. Here, all the definitions and explanations which have been made above with respect to the method and the organic water-soluble fertilizer with humic substance properties also apply to the water-soluble fertilizer which can be obtained with said method.

In the following, the invention is explained in detail with the help of an example.

### EXAMPLE

100 kg/hr of lignite dust are continuously taken out of a receiving vessel and supplied to a dispersing device (model Ytron ZC).

An aqueous 5% ammonia solution is continuously fed into the circulation system via the recirculation vessel, so that a mixture of 20 wt. % of lignite dust and 80 wt. % of ammonia solution, with respect to the total weight of the mixture, is formed. The mixture is pumped through the circulation system for a mean retention time of 180 min, whereby the lignite particles are intensively blended and reduced in size.

The resulting lignite suspension is continuously fed out from the recirculation vessel and supplied to the oxidation reactor.

The oxidation reactor has a vessel of a suitable volume. In this assembly, the lignite suspension is gassed with compressed air under stirring for a mean retention time of 120 min at 0.3 MPa (3 bar) and a temperature of 70° C. The oxidized product suspension is continuously fed out from the reactor via a receiving vessel, with the receiving vessel being under standard pressure.

The product suspension is continuously transferred from the receiving vessel into a centrifuge. The product suspension comprising a liquid and a solid phase is centrifugated at 4000 rpm. This way, the liquid phase is separated from the product suspension.

Subsequently, the separated liquid phase of the product suspension is continuously transferred into a thin layer evaporator at a rate of e.g., 300 L/hr and dried to a residual moisture of 25 wt. %, with respect to the total weight of the dried product, at an average temperature of 115° C. for a mean retention time of 0.5 hrs. This results in the organic water-soluble fertilizer with humic substance properties as a solid with 15 kg/h.

After drying the fertilizer is cooled and, if required, further agglomerated with agglomerating agent. In an additional step the solid organic water-soluble fertilizer can be packed and prepared for shipment.

The thus obtained water-soluble fertilizer was analyzed by means of elemental analysis:

C: 54%,

N: 8%,

H: 5%,

S: 0.3%.

Bonding forms of the nitrogen have been determined as follows:

Ammonium nitrogen: about 150 mg of test material are laced with 2 g of MgO and connected to a distillation plant according to Kjeldahl, e.g., by the firm Gerhard, model Vapodest. The apparatus automatically adds water and automatically distils NH₃ released into a receiver of boric acid. The content of NH₄⁺ of the sample is calculated from the consumption of boric acid determined by titration with NaOH solution.

Easy-to-hydrolyse amide nitrogen: in analogy to ammonium nitrogen, but 8% NaOH solution is added instead of MgO. The content of amide-N of the sample is calculated from the consumption of boric acid determined by titration with NaOH solution and considering the ammonium content of the sample.

Difficult-to-hydrolyse amide nitrogen: Calculation from the difference between the total content of N of the sample and the sum of ammonium and easy-to-hydrolyse amide nitrogen.

With respect to the total product the following values have been obtained:

ammonium nitrogen: 1.4%,

amide nitrogen, easy to hydrolyse: 0.8%,

amide nitrogen, difficult to hydrolyse: 5.8%.

### Example of Use

It was investigated in a test what influence the fertilizer according to the invention has on the vitality of tomato plants.

In particular, it was investigated how many resources the plant has to spend on its stress management during drought stress and consequently, is no longer available for biomass production (i.e., in the end exploitation rate).

Tomato plants have membranous oxidases (for example, respiratory burst oxidase homolog D (RbohD)) forming extracellular ROS (reactive oxygen species). Said oxidases are activated by signalling molecules of pathogens (so-called elicitors) and suddenly produce high concentrations of ROS (defense reaction) which have cytophathogenic effect on the pathogen and also on the own cells. For this reason, low concentrations of ROS entering the surrounding tissue (with respect to the site of attack) and thereupon are passed forward into the plant by RbohD, act as a signal and there, prepare a set of protective measures against oxidative stress by ROS (both, intra and extracellular). ROS signals are also activated in plants exposed to thermal stress (doi: 10.1080/14620316.2004.11511805). Moreover, however there is also prepared the ROS defense reaction against pathogens, so that when detecting a further elicitor the ROS defense reaction is stronger and more rapid (thus, there is an increased formation of ROS). Said preparation process is called priming (doi: 10.1016/j.jplph.2014.11.008).

It could be shown that treating the plant with the fertilizer according to the invention reduces the abiotic stress and the strength of the ROS defense reaction that was triggered by an elicitor.

Therefore, a reduced defense reaction to a biotic elicitor in the early growth phase is an indicator for a growth-promoting effect. In this sense, the fertilizer according to the invention (Novihum Liquid) was tested together with the conventional product (N25) as well as a product available on the market (competitor) against an untreated control.

The organic water-soluble fertilizer in form of a solid according to the invention (Novihum Liquid) which was used in the test was prepared in accordance with the method described in the application and had an ammonium nitrogen content of 2.0%, a content of easy-to-hydrolyse amide nitrogen of 0.8% and a content of difficult-to-hydrolyse amide nitrogen of 5.2%, with respect to the total amount of the fertilizer in the form of a solid according to the invention. The carbon-to-nitrogen ratio was 7.6.

For the treatment of the plants an aqueous solution of Novihum Liquid was prepared at a concentration of 0.01% and poured onto the substrate in an amount of 200 mL. Said treatment was carried out twice within 4 weeks.

The conventional product used in the test was prepared in accordance with the method of WO 2017/186852 and had an ammonium nitrogen content of 1.6%, a content of easy-to-hydrolyse amide nitrogen of 0.4% and a content of difficult-to-hydrolyse amide nitrogen of 2.4%, with respect to the total amount of the product. The carbon-to-nitrogen ratio was 13.

It was used as follows: 240 g were homogeneously mixed with 60 L of propagation substrate (Floraton 3 by Floragard).

The competitive product had an ammonium nitrogen content of 0.2%. No easy-to-hydrolyse nitrogen was found. The content of difficult-to-hydrolyse nitrogen was 0.7%. The carbon-to-nitrogen ratio was 43. The competitive product was used as follows.

The competitive product was present in a solid form. The competitive product was mixed to an aqueous solution at a concentration of 0.01%. The plant was watered twice with 200 mL of the aqueous solution each within 4 weeks.

The tomato plants used in the test had the same age and were cultivated in 3 L pots under otherwise the same conditions, so that the cultivation conditions differed only in the addition of different fertilizers. The test was done with 12 repetitions each.

The stress test was carried out 4 weeks after seeding. Carrying out such stress tests is described for example in WO 2019/179656 and is commercially offered and carried out by several service providers. In the present case, the stress test was carried out by Bex-Biotec GmbH & Co. KG in Munster.

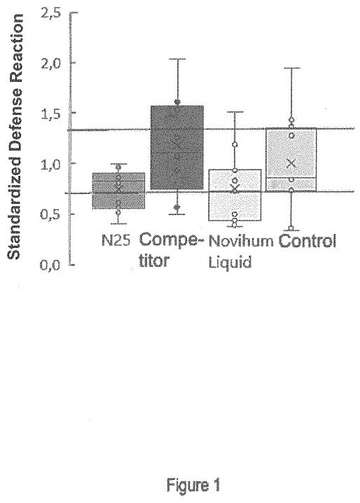

In FIG. 1, the ROS production is illustrated as a standardized defense reaction of the differently treated plants (tomato). The plants treated with the fertilizer according to the invention and the classical, water-insoluble product spend significantly less resources on the stress reaction than the control or a competitive product, respectively.

1. An organic water-soluble fertilizer, in the form of a solid, with humic substance properties comprising
carbon and nitrogen in a carbon-to-nitrogen ratio of 4 to 14, wherein
more than 0% and up to 30% of the total nitrogen content is chemically bound as ammonium nitrogen,
more than 0% and up to 20% of the total nitrogen content is chemically bound as easy-to-hydrolyse amide nitrogen and/or easy-to-hydrolyse amide-like bound nitrogen; and
at least 50% of the total nitrogen content is chemically bound as difficult-to-hydrolyse amide nitrogen and/or difficult-to-hydrolyse amide-like bound nitrogen.

2. The organic water-soluble fertilizer, in the form of a solid, according to claim 1, wherein the easy-to-hydrolyse amide nitrogen and/or easy-to-hydrolyse amide-like bound nitrogen is easy-to-hydrolyse amide nitrogen, and
wherein the difficult-to-hydrolyse amide nitrogen and/or difficult-to-hydrolyse amide-like bound nitrogen is difficult-to-hydrolyse amide nitrogen.

3. The organic water-soluble fertilizer, in the form of a solid, according to claim 1, which has a total nitrogen content of 3 to 11 wt. %, with respect to the dry weight of the fertilizer.

4. The organic water-soluble fertilizer, in the form of a solid, according to claim 1, which is obtained in by subjecting lignite to an oxidizing and ammoniating treatment.

5. The organic water-soluble fertilizer, in the form of a solid, according to claim 1, wherein the solid is present in powder form, as granules or as pellets.

6. The organic water-soluble fertilizer, in the form of a solid, according to claim 1, which has a residual moisture content of at most 30 wt. %, with respect to the total weight of the organic water-soluble fertilizer, in the form of a solid.

7. A method for the preparation of an organic water-soluble fertilizer, in the form of a solid, with humic substance properties according to claim 1, wherein the method is performed as a continuous method and comprises the following steps:
a) feeding lignite particles and/or lignin particles and an aqueous ammonia solution as well as optionally recovered product of step b) as starting materials into a dispersing circuit having a dispersing device, a recirculation container, and a circulation pump; dispersing the starting materials while simultaneously reducing the lignite particles in size until a suspension of the lignite particles and/or the lignin particles and the aqueous ammonia solution is formed; taking the suspension out of the dispersing circuit and transferring it to step b);
b) oxidizing the suspension obtained in step a) in an oxidation reactor with an oxygen-containing oxidizing agent at a temperature of <100° C., thereby forming a product suspension;
c) separating a liquid phase from the product suspension; and
d) drying the liquid phase obtained in step c) to generate the organic water-soluble fertilizer with humic substance properties as a solid.

8. The method according to claim 7, wherein the lignite particles and/or the lignin particles and the aqueous ammonia solution are lignite particles.

9. The method according to claim 7, wherein step c) and/or step d) comprises removing free ammonia and after step d), step e) takes place:
e) cooling the solid organic water-soluble fertilizer obtained in step d).

10. The method according to claim 7, wherein the liquid phase separated in step c) is a colloidal suspension.

11. The method according to claim 7, wherein the separation in step c) is by centrifugation.

12. A method comprising applying the liquid phase obtained in step c) of the method according to claim 7 as a fertilizer to soil.

13. The method according to claim 12, which comprises applying the liquid phase obtained in step c) to the soil of already existing plant stands for subsequent soil conditioning and/or as a biostimulant for reducing plant stress.

14. A method comprising applying the organic water-soluble fertilizer, in the form of a solid, with humic substance properties according to claim 1 to the soil of already existing plant stands for subsequent soil conditioning and/or as a biostimulant for reducing plant stress.

15. An organic water-soluble fertilizer, in the form of a solid, with humic substance properties which is obtained in accordance with the method according to claim 7.

16. The organic water-soluble fertilizer, in the form of a solid, according to claim 1, wherein more than 0% and up to 20% of the total nitrogen content is chemically bound as easy-to-hydrolyse amide nitrogen.

17. The organic water-soluble fertilizer, in the form of a solid, according to claim 1, wherein at least 50% of the total nitrogen content is chemically bound as difficult-to-hydrolyse amide nitrogen.

18. The organic water-soluble fertilizer, in the form of a solid, according to claim 2, which has a total nitrogen content of 3 to 11 wt. %, with respect to the dry weight of the fertilizer.

19. The method according to claim 8, wherein the liquid phase separated in step c) is a colloidal suspension.

20. The method according to claim 9, wherein the liquid phase separated in step c) is a colloidal suspension.
